(19) United States
(12) Patent Application Publication
(10) Pub. No.: US 2016/0027391 A1
(43) Pub. Date: Jan. 28, 2016

(54) DUAL-SIDED DISPLAY

(71) Applicant: HEWLETT-PACKARD DEVELOPMENT COMPANY, LP, HOUSTON, TX (US)

(72) Inventors: GARY GIBSON, PALO ALTO, CA (US); JOHN CHRISTOPHER RUDIN, BRISTOL (GB)

(21) Appl. No.: 14/770,804

(22) PCT Filed: Mar. 19, 2013
(86) PCT No.: PCT/US2013/033007

§ 371 Date: Aug. 26, 2015

(51) Int. Cl. G09G 3/36; G06F 3/14

(52) U.S. Cl. CPC G09G 3/3607; G06F 3/1423; G09G 2320/0666; G09G 2320/0613; G09G 2320/0686

(57) ABSTRACT

A dual-sided display includes outer layers switchable between a transparent state and an opaque state and inner layers disposed between the outer layers and switchable between the transparent state and a colored state.

### BACKGROUND

Various display technologies may be used to display images to a viewer. These images, however, are typically viewable on only one side of a display such that a viewer on the other side of the display sees the back of the display rather than any images formed by the display. In addition, because the back of a display is usually an opaque housing or other apparatus, a viewer usually cannot see through a display.

### BRIEF DESCRIPTION OF THE DRAWINGS

FIG. 1 is a schematic diagram illustrating one sample of a dual-sided display.

FIG. 2 is a schematic diagram illustrating one example of a layer with pixels for transmitting or scattering light from the visible spectrum.

FIG. 3 is a schematic diagram illustrating one example of a layer with pixels for transmitting or absorbing light from the visible spectrum.

FIGS. 4A-4B are schematic diagrams illustrating one example of an electrokinetic pixel are for transmitting or absorbing light from the visible spectrum,

FIGS. 5A-5B are schematic diagrams illustrating one example of a guest-host liquid crystal pixel for transmitting or absorbing light from the visible spectrum.

FIG. 6 is a schematic diagram illustrating one example of a duel-sided display.

FIG. 7 is a block diagram illustrating one embodiment of a processing system for controlling the operation of a dual-sided display.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As used herein, the term “visible light”refers to electromagnetic radiation having wavelengths that generally range from 400 to 650 nm and form the visible spectrum. The term “red light” refers to electromagnetic radiation having wavelengths of 580 to 650 nm. The term “green light” refers to electromagnetic radiation having wavelengths of 490 to 580 nm. The term “blue light” refers to electromagnetic radiation having wavelengths of 400 to 490 nm.

As used herein, the term “pixel ” refers to a display element that is independently controllable to produce at least a portion of a visual effect. The term “array” refers to a set of one or more pixels.

As described herein, a dual-sided display is provided that is configured to switch between transparent, opaque, and image display modes on one or both sides of the display. In the opaque mode, the dual-sided display prevents substantially all visible light from transmitting through the display to provide an opaque appearance on one or both sides of the display. In the transparent mode, the dual-sided display allows substantially all visible light to transmit through the display to provide a transparent view through both sides of the display. In the image display mode, the dual-sided display displays selected images to one or both sides of the display to provide the images as visual effects.

The modes may be used in combination to provide different visual effects on each side of the display. For example, the display may be operated in the opaque mode on one side to present an opaque visual effect (e.g., solid white or solid black) to that side while the display is operated in the image display mode on the other side to provide an image as the visual effect on that side. In another example, the display may be operated in the transparent mode and the image display mode to provide an image as the visual effect on both sides. The dual-sided display may serve as an information display, a controllable window, a security shield, or an architectural cover, for example.

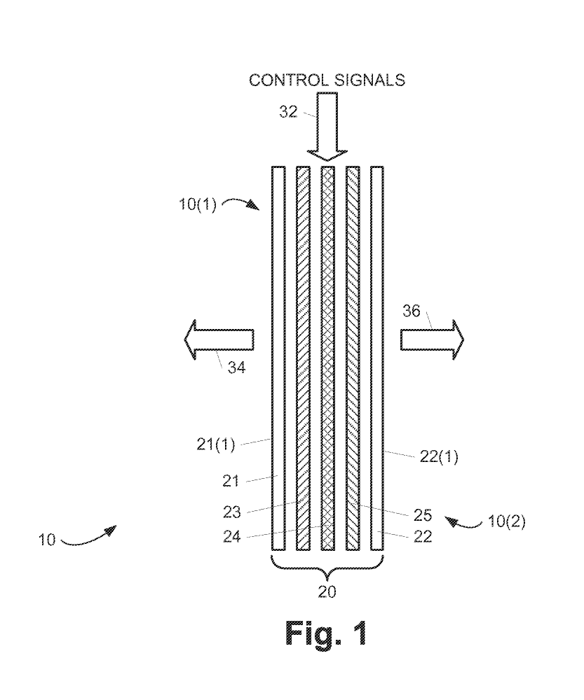

FIG. 1 is a schematic diagram illustrating one example of a dual-sided display 10. Display 10 includes a set of light modulation layers 20, where layers 20 include outer layers 21 and 22 and inner layers 23, 24, and 25. An outer surface 21(1) of outer layer 21 forms one side 10(1) of display 10, and an outer surface 22(1) of outer layer 22 forms an opposite side 10(2) of display 10.

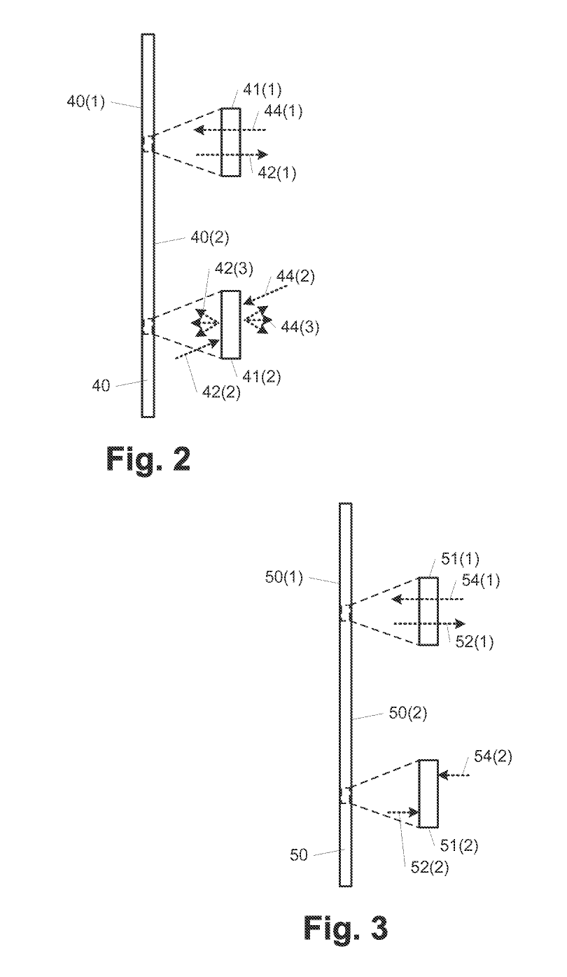

Outer layers 21 and 22 each include a respective outer array of one or more outer pixels. Each outer pixel is switchable between a transparent state and an opaque state. In the transparent state, the outer pixels allow transmission across the entire spectrum of visible light through corresponding layer 21 or 22. In the opaque state, the outer pixels prevent transmission across the entire spectrum of visible light through corresponding layer 21 or 22. To prevent transmission in the opaque state, the outer pixels may scatter (i.e., diffusively reflect) visible light as will be described in additional detail below with reference to FIG. 2 or absorb visible light as will be described in additional detail below with reference to FIG. 3. Outer layers 21 and 22 may each include one of an electrokinetic layer, an electrophoretic layer, an electrochromic layer, an electrowetting layer, a guest-host liquid crystal layer, a polymer dispersed liquid crystal layer, or a twisted nematic liquid crystal (TN-LC) layer with a polarizer.

Inner layers 23-25 are disposed between outer layers 21 and 22 and each include a respective inner array of one or more inner pixels. Each inner pixel is switchable between a transparent state and a colored state. In the transparent state, the inner pixels allow transmission across the entire spectrum of visible light through corresponding layer 23, 24, or 25. In the colored state, the inner pixels prevent transmission of a portion of the spectrum of visible light through corresponding layer 23/24, or 25. To prevent transmission of the portion in the colored state, the inner pixels may scatter (i.e., diffusively or specularly reflect) the portion of visible light as will be described in additional detail below with reference to FIG. 2 or adsorb the portion of visible light as will be described in additional detail below with reference to FIG. 3. Inner layers 23-25 may each include one of an electrokinetic layer, an electrophoretic layer, an electrochromic layer, an electrowetting layer, a guest-host liquid crystal layer, or a polymer dispersed liquid crystal layer.

The inner arrays of inner pixels of layers 23-25 may each correspond to different portions of the visible spectrum (i.e., different colors). In one example where the inner pixels scatter a portion of visible light in the colored state, layers 23-25 may be red, green, and blue layers, respectively, with respective arrays of inner pixels that scatter red, green, and blue light, respectively, in the colored state. In another example where the inner pixels absorb a portion of visible light in the colored state, layers 23-25 may be cyan, yellow, and magenta layers, respectively, with respective arrays of inner pixels that absorb cyan, yellow, and magenta light, respectively, in the colored state. In both examples, inner layers 23-25 may combine to modulate light across the visible spectrum to form images by selectively switching inner pixels in inner layers 23-25 between the transparent and colored states. Various stacking orders of layers 23-25 may be used.

The number, size, shape, and arrangement of the outer pixels of layers 21 and 22 and the inner pixels of layers 23-25 may be selected to form any suitable configuration of the set of layers 20. Any of layers 21-25 may have the same or different number, size, shape, and/or arrangement of pixels as any other layer 21-25. In one specific example, layers 21-25 each have the same configuration (i.e., the same number, size, shape, and arrangement) of pixels where the corresponding pixels of each pixel array are aligned. In another specific example, outer layers 21-22 each have one configuration and inner layers 23-25 have another configuration that differs from the configuration of outer layers 21-22. Layers 21-25 may also include any suitable combination of scattering and/or absorbing layers.

Display 10 is configured to switch between transparent, opaque, and image display modes on one or both sides 10(1) and 10(2) in response to control signals 32. The selection of the modes by control signals 32 produces visual effects 34 and 36 to viewers on sides 10(1) and 10(2), respectively. Visual effects 34 and 36 may each include a transparent or semi-transparent view through display 10, an opaque appearance (e.g., solid white or solid black), and/or an image formed by inner layers 23-25 and/or outer layers 21-22.

In the transparent mode, display 10 allows visible light to transmit, at least partially, through all layers 21-25. Thus, control signals 32 switch at least portions of all layers 21-25 to the transparent state to implement the transparent mode. In the transparent mode, control signals 32 may also switch selected pixels in any or all of layers 21-25 to the opaque state to control the amount of transparency (i.e., from fully transparent to partially transparent) and/or produce a grayscale, colored, or imaged transparent view as visual effects 34 and/or 36.

In the opaque mode, display 10 prevents visible light from transmitting through display 10 (i.e., from side 10(1) to 10(2) and/or from side 10(2) to 10(1)) in one or more of several possible ways.

If layers 21 and 22 scatter visible light in the opaque state, layer 21 may be fully switched to the opaque-state by control signals 32 to produce an opaque, sold white appearance as visual effect 34 on side 10(1). Alternatively, layer 21 may be fully switched to the transparent slate by control signals 32, layer 22 may be fully switched to the opaque state by control signals 32, and layers 23-25 may be fully switched to the transparent state by control signals 32 by control signals 32 to produce the opaque, solid white appearance as visual effect 34 on side 10(1). If layers 23-25 also scatter visible light in the opaque state, layer 21 may be fully switched to the transparent state by control signals 32 and layers 23-25 could also be fully switched to the opaque state by control signals 32 to produce the opaque, solid white appearance as visual effect 34 on side 10(1).

If layers 21 and 22 absorb visible light in the opaque state, layer 21 may be fully switched to the opaque state by control signals 32 to produce an opaque, solid black appearance as visual effect 34 on side 10(1). Alternatively, layer 21 may be fully switched to the transparent state by control signals 32, layer 22 may be fully switched to the opaque state by control signals 32, and layers 23-25 may be fully switched to the transparent state by control signals 32 by control signals 32 to produce the opaque, solid black appearance as visual effect 34 on side 10(1). If layers 23-25 also absorb visible light in the opaque state, layer 21 may be fully switched to the transparent state by control signals 32 and layers 23-25 could also be fully switched to the opaque state by control signals 32 to produce the opaque, solid black appearance as visual effect 34 on side 10(1).

In the above opaque state examples, a viewer on side 10(1) sees an opaque appearance as visual effect 34 and cannot see through display 10. A viewer on side 10(2) also cannot see through display 10 and may see either an opaque appearance as visual effect 36 or an image formed by layers 23-25 when layer 22 is in the transparent state and layers 23-25 are in the colored state with inner pixels that scatter portions of light as in the example of FIG. 2 below.

Similar visual effects 36 may be produced for a viewer on side 10(2) by reversing the operation of layers 21 and 22 in the opaque mode examples just described.

In the image display mode, display 10 displays selected images on one or both sides 10(1) and 10(2) of display 10. Layers 23-25 may be selectively switched to the transparent and colored states by control signals 32 to form the images. To form the images as visual effects 34 on side 10(1), layer 21 may be fully or partially switched to the transparent state by control signals 32 to allow a viewer on side 10(1) to see the images through layer 21. Layer 22 may be fully switched to the opaque state by control signals 32 to provide a background for the images seen by the viewer on side 10(1) or may be fully or partially switched to the transparent state by control signals 32 to allow the viewer on side 10(1) to partially see through display 10. In the latter case, viewer on side 10(2) may also see or partially see the images formed by layers 23-25 and partially see through display 10 as visual effects 36.

Similar visual effects 36 may be produced for a viewer on side 10(2) by reversing the operation of layers 21 and 22 in the image display mode examples just described.

FIG. 2 is a schematic diagram illustrating one example of a layer 40 with pixels 41 for transmitting or scattering light from the visible spectrum. A 41(1) illustrates the transparent state for pixels in any of layers 21-25. In the transparent state, pixel 41(1) transmits light 42(1) from across the visible spectrum from a side 40(1) to a side 40(2) of layer 40 and transmits light 44(1) torn across the entire visible spectrum from side 40(2) to side 40(1).

A pixel 41(2) illustrates the opaque state for pixels in outer layers 21-22 and the colored state for pixels in inner layers 23-25. In the opaque state of layers 21-22, pixel 41(2) scatters light 42(2) from across the entire visible spectrum as scattered light 42(3) and scatters substantially light 44(2) from across the entire visible spectrum as scattered light 44(3) to prevent transmission of substantially all visible light through pixel 41(2).

In the colored state of layers 23-25, pixel 41(2) scatters light 42(2) from a portion of the visible spectrum as scattered light 42(3) and transmits the remainder of the visible spectrum (not shown). Pixel 41(2) also scatters light 44(2) from the portion of the visible spectrum as scattered light 44(3) and transmits the remainder of the visible spectrum (not shown). By scattering the portion of the visible spectrum of light 42(2) and 44(2) from both sides 40(1) and 40(2), pixel 41(2) prevents transmission of substantially all of the portion through pixel 41(2).

FIG. 3 is a schematic diagram illustrating one example of a layer 50 with pixels 51 for transmitting or absorbing light from the visible spectrum. A pixel 51(1) illustrates the transparent state for pixels in any of layers 21-25. In the transparent state, pixel 51(1) transmits light 52(1) from across the entire visible spectrum from a side 50(1) to a side 50(2) of layer 50 and transmits light 54(1) from across the entire visible spectrum from side 50(2) to side 50(1).

A pixel 51(2) illustrates the opaque state for pixels in outer layers 21-22 and the colored state for pixels in inner layers 23-25. In the opaque state of layers 21-22, pixel 51(2) absorbs light 52(2) from across the entire visible spectrum and absorbs light 54(2) from across the entire visible spectrum to prevent transmission of substantially all visible light through pixel 51(2).

In the colored state of layers 23-25, pixel 51(2) absorbs light 52(2) from a portion of the visible spectrum and transmits the remainder of the visible spectrum (not shown). Pixel 51(2) also absorbs light 54(2) from the portion of the visible spectrum and transmits the remainder of the visible spectrum (not shown). By absorbing the portion of the visible spectrum of light 52(2) and 54(2) from both sides 50(1) and 50(2), pixel 51(2) prevents transmission of substantially all of the portion of the visible spectrum through pixel 51(2).

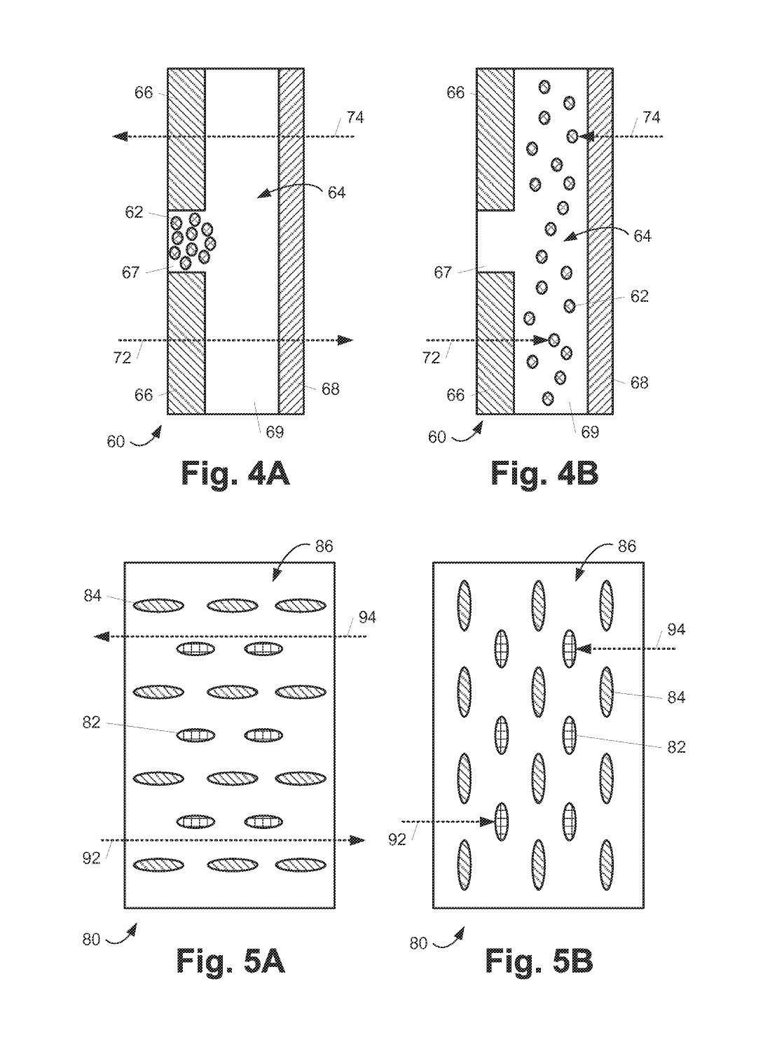

The inner and outer pixels of display 10 in the above examples may include electrokinetic pixels 60 as shown in FIGS. 4A-4B of guest-host liquid crystal pixels 80 as shown in FIGS. 5A-5B in various embodiments.

FIGS. 4A-4B are schematic diagrams illustrating one example of an electrokinetic pixel 60 for transmitting or absorbing light 72 and 74 from the visible spectrum. Pixel 60 includes particles 82 in a fluid 64. Transparent structural elements 66 and 68 enclose particles 82 and fluid 84. Element 66 forms a hole 67.

A combination of electrophoretic and electrokinetic forces may be used to collect particles 62 in hole 67 as shown in FIG. 4A and disperse particles 62 across a volume 69 of pixel 60 as shown in FIG. 4B in response to voltages applied across pixel 60. When collected in hole 67, particles 62 do not substantially block light 72 and 74 from both sides of pixel 60 from transmitting through pixel 60 as shown in FIG. 4A. Thus, pixel 60 provides the transparent state for any of layers 21-25 by collecting particles 82 in hole 67.

When dispersed throughout pixel 60, particles 62 block light 72 and 74 from both sides of pixel 60 from transmitting through pixel 60 as shown in FIG. 4B (e.g., by scattering or absorbing the light as shown in FIGS. 2 and 3, respectively, depending on the type of particles 62). Depending on the type of particles 62, particles 62 may block all or a portion of the visible spectrum of light 72 and 74.

In one example of the opaque state for layers 21-22, particles 62 may include titania particles to scatter the entire visible spectrum of light 72 and 74 to prevent transmission of the entire visible spectrum of light through pixel 60. In another example of the opaque state for layers 21-22, particles 62 may include light absorbing particles, such as carbon black, to absorb the entire visible spectrum of light 72 and 74 to prevent transmission of the entire visible spectrum of light through pixel 60.

In one example of the colored state for layers 23-25, particles 62 may include reflective particles to scatter desired portions of the visible spectrum of light 72 and 74 to prevent transmission of the desired portions of visible spectrum of light through pixel 60. In another example of the colored state for layers 23-25, particles 62 may include absorbing particles, such as pigment particles, to absorb desired portions of the visible spectrum of light 72 and 74 to prevent transmission of the desired portions of visible spectrum of light through pixel 60.

FIGS. 5A-5B are schematic diagrams illustrating one example of a guest-host liquid crystal pixel 80 for transmitting or absorbing light 92 and 94 from the visible spectrum. Pixel 80 includes dichroic dye molecules or particles 82 (referred to as dichroic dye molecules 82 for clarity hereafter) and liquid crystal molecules 84 in a fluid 86 that are enclosed by transparent structural elements (not shown).

Voltages applied to electrodes (not shown) may be used to orient liquid crystal molecules 84 in fluid 86 and in doing so, re-orienting dichroic dye molecules 82, When dichroic dye molecules 82 are aligned parallel to the direction of light 92 and 94 through pixel 80, dichroic dye molecules 82 do not block light 92 and 94 from both sides of pixel 80 from transmitting through pixel 80 as shown in FIG. 5A. Thus, pixel 80 provides the transparent state for any of layers 21-25 by aligning dichroic dye molecules 82 parallel to the direction of light 92 and 94 through pixel 80.

When dichroic dye molecules 82 are aligned orthogonal to the direction of light 92 and 94 through pixel 80, dichroic dye molecules 82 do block all or a portion of the visible spectrum light 92 and 94 from both sides of pixel 80 from transmitting through pixel 80 as shown in FIG. 5B (e.g., by absorbing the light as shown in FIG. 3 depending on the type of dichroic dye molecule's 82).

In the opaque state for layers 21-22, dichroic dye molecules 82 absorb the entire visible spectrum of light 92 and 94 to prevent transmission of the entire visible spectrum of light through pixel 80. In the colored slate for layers 23-25, dichroic dye molecules 82 absorb desired portions of the visible spectrum of light 92 and 94 to prevent transmission of the desired portions of visible spectrum of light through pixel 80.

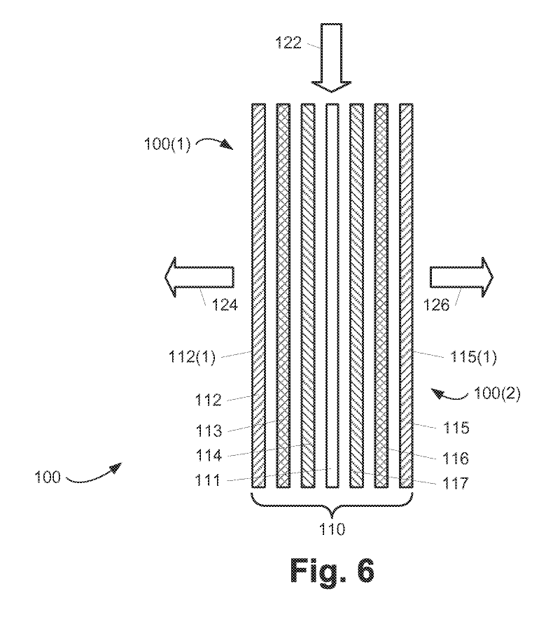

FIG. 6 is a schematic diagram illustrating one example of a dual-sided display 100. Display 100 includes a set of light modulation layers 110, where layers 110 include an inner layer 111, a set of outer layers 112-114, and a set of outer layers 115-117. An outer surface 112(1) of outer layer 112 forms one side 100(1) of display 100, and an outer surface 115(1) of outer layer 115 forms an opposite side 100(2) of display 100.

Inner layer 111 includes an inner array of one or more inner pixels. Each inner pixel is switchable between a transparent slate and an opaque state. In the transparent state, the inner pixels allow transmission across the entire spectrum of visible light through layer 111. In the opaque state, the inner pixels prevent transmission across the entire spectrum of visible light through corresponding layer 111. To prevent transmission in the opaque state, the inner pixels for inner layer 111 may scatter (i.e., diffusively reflect) visible light as described above with reference to FIG. 2 or absorb visible light as described with reference to FIG. 3. Inner layer 111 is disposed between the set of outer layers 112-114 and the set of outer layers 115-117. Inner layer 111 includes one of an electrokinetic layer, an electrophoretic layer, an electrochromic layer, an electrowetting layer, a guest-host liquid crystal layer, a polymer dispersed liquid crystal layer, or a twisted nematic liquid crystal (TN-LC) layer with a polarizer.

Each outer layer 112-117 includes a respective outer array of one or more outer pixels. Each outer pixel is switchable between a transparent state and a colored state. In the transparent state, the outer pixels allow transmission across the entire spectrum of visible light through the corresponding layer 112-117. In the colored state, the outer pixels prevent transmission of a portion of the spectrum of visible light through the corresponding layer 112-117. To prevent transmission of the portion in the colored state, the outer pixels for outer layers 112-117 may scatter (i.e., diffusively or specularly reflect) the portion of visible light as described with reference to FIG. 2 or absorb the portion of visible light as described with reference to FIG. 3. Outer layers 112-117 may each include one of an electrokinetic layer, an electrophoretic layer, an electrochromic layer, an electrowetting layer, a guest-host liquid crystal layer, or a polymer dispersed liquid crystal layer.

The outer arrays of outer pixels of layers 112-114 may each correspond to different portions of the visible spectrum (i.e., different colors). Similarly, the outer arrays of the pixels of layers 115-117 may each correspond to different portions of the visible spectrum (i.e., different colors).

In one example where the outer pixels scatter a portion of visible light in the colored state, layers 112-114 may be red, green, and blue layers, respectively, with respective arrays of outer pixels that scatter red, green, and blue light, respectively, in the colored state. Likewise, layers 115-117 may be red, green, and blue layers, respectively, with respective arrays of outer pixels that scatter red, green, and blue light, respectively, in the colored state.

In another example where the enter pixels absorb a portion of visible light in the colored state, layers 112-114 may be cyan, yellow, and magenta layers, respectively, with respective arrays of outer pixels that absorb cyan, yellow, and magenta light, respectively, in the colored state. Likewise, layers 115-117 may be cyan, yellow, and magenta layers, respectively, with respective arrays of outer pixels that absorb cyan, yellow, and magenta light, respectively, in the colored state.

In both examples, outer layers 112-114 may combine to modulate light across the visible spectrum to form images by selectively switching outer pixels in outer layers 112-114 between the transparent and colored states. Similarly, outer layers 115-117 may combine to modulate light across the visible spectrum to form images by selectively switching outer pixels in outer layers 115-117 between the transparent and colored states. Various stacking orders of layers 112-114 and 115-117 may be used.

The number, size, shape, and arrangement of the inner pixels of layer 111 and the outer pixels of layers 112-117 may be selected to form any suitable configuration of the set of layers 110. Any of layers 111-117 may have the same or different number, size, shape, and/or arrangement of pixels as any other layer 111-117. In one specific example, layers 111-117 each have the same configuration (i.e., the same number, size, shape, and arrangement) of pixels where the corresponding pixels of each pixel array are aligned. In another specific example, outer layers 112-117 each have one configuration and inner layer 111 has another configuration that differs from the configuration of outer layers 112-117. Layers 111-117 may also include any suitable combination of scattering and/or absorbing layers.

Display 100 is configured to switch between transparent, opaque, and image display modes on one or both sides 100(1) and 100(2) in response to control signals 122. The selection of the modes by control signals 122 produces visual effects 124 and 126 to viewers on sides 100(1) and 100(2), respectively. Visual effects 124 and 126 may each include a transparent or semi-transparent view through display 100, an opaque appearance (e.g., solid white or solid black), and/or one or more images formed by inner layer 111 and/or outer layers 112-117.

In the transparent mode, display 100 allows visible light to transmit, at least partially, through all layers 112-117. Thus, control signals 122 switch at least portions of all layers 112-117 to the transparent state to implement the transparent mode. In the transparent mode, control signals 122 may also switch selected pixels in any or all of layers 112-117 to the opaque state to control the amount of transparency (i.e., from fully transparent to partially transparent) and/or produce a grayscale, colored, or imaged transparent view as visual effects 124 and/or 126.

In the opaque mode, display 100 prevents visible light from transmitting through display 100 (i.e., from side 100(1) to 100(2) and/or from side 100(2) to 100(1)) in one or more of several possible ways.

If layers 112-114 scatter visible light in the opaque state, then layers 112-114 may be switched to the opaque state by control signals 122 to produce an opaque, solid white appearance as visual effect 124 on side 100(1). Alternatively, if layer 111 scatters visible light in the opaque state, then layers 112-114 may be switched to the transparent state by control signals 122 and layer 111 may be switched to the opaque state by control signals 122 to produce an opaque, sold white appearance as visual affect 124 on side 100(1). If layers 115-117 also scatter visible light in the opaque state, layers 111-114 may be fully switched to the transparent state by control signals 122 and layers 115-117 may be fully switched to the opaque state by control signals 122 to produce the opaque, solid white appearance as visual effect 124 on side 100(1).

If layers 112-114 absorb visible light in the opaque state, then layers 112-114 may be switched to the opaque state by control signals 122 to produce an opaque, black appearance as visual affect 124 on side 100(1). Alternatively, if layer 111 absorbs visible light in the opaque state, then layers 112-114 may be switched to the transparent state by control signals 122 and layer 111 may be switched to the opaque state by control signals 122 to produce an opaque, black appearance as visual effect 124 on side 100(1). If layers 115-117 also absorb visible light in the opaque state, layers 111-114 may be fully switched to the transparent state by control signals 122 and layers 115-117 may be fully switched to the opaque state by control signals 122 to produce the opaque, solid black appearance as visual effect 124 on side 100(1).

In the above opaque state examples, a viewer on side 100(1) sees an opaque appearance as visual effect 124 and cannot see through display 100. A viewer on side 100(2) also cannot see through display 100 and may see either an opaque appearance as visual effect 126 or an image formed by layers 115-117 when layers 115-117 are in the colored state.

Similar visual effects 126 may be produced for a viewer on side 100(2) by reversing the operations of the sets of layers 112-114 and 115-117 as described in the above examples.

In the image display mode, display 100 displays one or more selected images on one or both sides 100(1) and 100(2) of display 100. Layers 112-114 and layers 115-117 may be separately and selectively switched to the transparent and colored states by control signals 122 to form one or more images. To form an image as a visual effect 124 on side 100(1), layers 112-114 may form the image and layer 111 may be fully switched to the opaque state by control signals 122 to provide a background for the images seen by the viewer on side 100(1) or may be fully or partially switched to the transparent state by control signals 122 to allow the viewer on side 100(1) to partially see through display 100. In the latter case, viewer on side 100(2) may also see or partially see the images formed by layers 112-114 and partially see through display 100 as visual effects 126. Also in the latter case, layers 115-117 may also be used to form the same or a different image that is seen by the viewers on both sides 100(1) and 100(2).

Similar visual effects 126 may be produced for a viewer on side 100(2) by reversing the operations of the sets of layers 112-114 and 115-117 as described in the above examples.

The inner and outer pixels of display 100 in the above examples may include electrokinetic pixels 60 as shown in FIGS. 4A-4B or guest-host liquid crystal pixels 80 as shown in FIGS. 5A-5B in various embodiments.

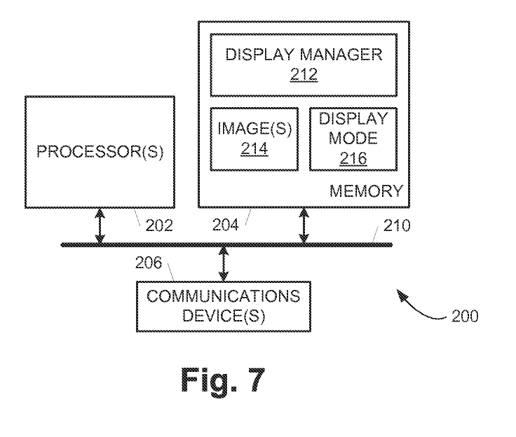

FIG. 7 is a block diagram illustrating one embodiment of a processing system 200 for controlling the operation of dual-sided display 10 in one example and dual-sided display 100 in another example. Processing system 200 includes a set of one or more processors 202, a memory system 204, and any suitable number of communication devices 206. Processors 202, memory system 204, and communication devices 206 communicate using a set of interconnections 210 that includes any suitable type, number, and/or configuration of controllers, buses, interfaces, and/or other weird or wireless connections.

Processing system 200 represents any suitable processing device, or portion of a distributed processing device, configured to generate control signals 32 for display 10 and/or control signals 122 for display 100 as described above. Each processor 202 is configured to access and execute instructions stored in memory system 204. Each processor 202 may execute the instructions in conjunction with or in response to information received from communication devices 206. Each processor 202 is also configured to access and store data in memory system 204.

Memory system 204 includes any suitable type, number, and configuration of volatile or non-volatile machine-readable storage media configured to store instructions and data. Examples of machine-readable storage media in memory system 204 include hard disk drives, random access memory (RAM), read only memory (ROM), flash memory drives and cards, and other suitable types of magnetic and/or optical disks. The machine-readable storage media are considered to be part of an article or article of manufacture. An article or article of manufacture refers to one or more manufactured components.

Memory system 204 stores a display manager 212, any suitable number of images 214, and a display mode 216. In embodiments for display 10, display manager 212 generates control signals 32 to cause display 10 to display images 214 in the display mode or combination of display modes (i.e., transparent, opaque, and/or image display modes) indicated by display mode 216. In embodiments for display 100, display manager 212 generates control signals 122 to cause display 100 to display images 214 in the display mode or combination of display modes (i.e., transparent, opaque, and/or image display modes) indicated by display mode 216.

Communications devices 206 include any suitable type, number, and/or configuration of communications devices configured to allow processing system 200 to communicate across one or more wired or wireless connections, ports, and/or networks. In embodiments for display 10, one or more communications devices 206 provide control signals 32 to display 10. In embodiments for display 100, one or more communications devices 206 provide control signals 122 to display 10.

What is claimed is:

1. A dual-sided display comprising:
first and second outer layers having first and second outer arrays of outer pixels, respectively, where each of the outer pixels in the first and the second outer arrays is switchable between a transparent state and an opaque state; and
first and second inner layers disposed between the list and the second outer layers and having first and second inner arrays of inner pixels, respectively, where each of the inner pixels in the first and the second inner arrays is switchable between the transparent state and a colored state.

2. The dual-sided display of claim 1 wherein each of the outer pixels in the first and the second outer arrays allow transmission across the entire spectrum of visible light in the transparent state and prevent transmission across the entire spectrum of visible light in the opaque state.

3. The dual-sided display of claim 1 wherein each of the outer pixels in the first and the second outer arrays scatter visible light in the opaque state.

4. The dual-sided display of claim 1 wherein each of the outer pixels in the first and the second outer arrays absorb visible light in the opaque state.

5. The dual-sided display of claim 1 wherein each of the inner pixels in the first inner array allow transmission across the entire spectrum of visible light in the transparent state and prevent transmission of a first portion of the spectrum of visible light in the colored state, wherein each of the inner pixels in the second inner array allow transmission across the entire spectrum of visible light in the transparent state and prevent transmission of a second portion of the spectrum of visible light ins the colored state, and wherein the first portion of the spectrum of visible light differs from the second portion of the spectrum of visible light.

6. The dual-sided display of claim 5 further comprising:
a third inner layer disposed between the first and fee second outer layers and having a third inner array of inner pixel where each of the inner pixels in the third inner array is switchable between the transparent state and the colored state;
wherein each of the inner pixels in the third inner array allow transmission across the entire spectrum of visible light in the transparent state and prevent transmission of a third portion of the spectrum of visible light in the colored state, and wherein the first portion of the spectrum of visible light differs from the second portion of the spectrum of visible light and the third portion of the spectrum of visible light.

7. The dual-sided display of claim 1 wherein each of the first and the second outer layers and each of the first and the second inner layers includes one of an electrokinetic layer, an electrophoretic layer, an electrochromic layer, an electrowetting layer, a guest-host liquid crystal layer, a polymer dispersed liquid crystal layer, or a twisted nematic liquid crystal (TN-LC) layer with a polarizer.

8. The dual-sided display of claim 1 wherein a first number of pixels of the first and the second outer arrays differs from a second number of pixels of the first and the second inner arrays.

9. A method of controlling a dual-sided display, the method comprising:
providing first control signals to a first outer layer that forms a first side of the display to selectively allow or prevent transmission across the entire spectrum of visible light through the first outer layer;
providing second control signals to a second outer layer that forms a second side of the display to selectively allow or prevent transmission across the entire spectrum of visible light through the second outer layer; and
providing third control signals to a plurality of color layers disposed between the first and the second outer layers to form an image with the plurality of color layers.

10. The method of claim 9 wherein at least a first portion of the image is visible on the first side of the display when the first control signals cause a corresponding portion of the first outer layer to allow transmission across the entire spectrum of visible light through the first outer layer.

11. The method of claim 10 wherein at least a second portion of the image is visible on the second side of the display when the second control signals cause a corresponding portion of the second outer layer to allow transmission across the entire spectrum of visible light through the second outer layer.

12. A dual-sided display comprising:
first and second outer layers to allow transmission across the entire spectrum of visible light in a transparent state and to modulate respective first and second portions of the spectrum of visible light in a colored state, the first portion of the spectrum of visible light differing from the second portion of the spectrum of visible light;
an inner layer to allow transmission across the entire spectrum of visible light in the transparent state and to prevent transmission of the entire spectrum of visible light in an opaque state; and
third and fourth outer layers to allow transmission across the entire spectrum of visible light in the transparent state and to modulate respective third and fourth portions of the spectrum of visible light in the colored state, the third portion of the spectrum of visible light differing from the fourth portion of the spectrum of visible light;
wherein the inner layer is disposed between the second and the third outer layers.

13. The apparatus of claim 12 wherein the inner array includes an array of pixels, and wherein each of the pixels scatters visible light in the opaque state.

14. The apparatus of claim 12 wherein the inner array includes an array of pixels, and wherein each of the pixels absorbs visible light in the opaque state.

15. The apparatus of claim 12 wherein the inner layer and each of the first, the second, the third, and the fourth outer layers includes one of an electrokinetic layer, an electrophoretic layer, an electrochromic layer, an electrowetting layer, a guest-host liquid crystal layer, a polymer dispersed liquid crystal layer, or a twisted nematic liquid crystal (TN-LC) layer with a polarizer.
